(19) United States
(12) Patent Application Publication
(10) Pub. No.: US 2012/0011774 A1
(43) Pub. Date: Jan. 19, 2012

(54) Barrier Gate

(76) Inventor: Roger R. Arnaud, Stateline, NV (US)

(21) Appl. No.: 12/836,675

(22) Filed: Jul. 15, 2010

(51) Int. Cl. E01F 13/06; E05F 15/02

(52) U.S. Cl. 49/49

(57) ABSTRACT

A barrier gate comprising: a generally stationary barrier frame; a pivot member in communication with the barrier frame; a swing arm in communication with the pivot member, and rotatable with respect to the barrier frame; a barrier arm in fixed communication with the swing arm; an electro-magnet in fixed communication with one of the barrier frame and the swing arm, the electro-magnet is energizable and de-energizable; a strike plate in fixed communication the other of the barrier frame and the swing arm, and magnetically attachable to the electro-magnet when the electro-magnet is energized, and when the strike plate is magnetically attached to the electro-magnet the barrier gate is in a first position, when the swing arm is rotated generally about 90° from the first position the barrier gate is in an second position; at least one force acting on the swing arm such that the force tends to rotate the swing arm from the first position to the second position; where when the electro-magnet is energized and magnetically attached to the strike plate, the barrier gate is in a first position, and further when the electro-magnet is de-energized when in the first position, the swing arm will generally rotate about 90° from the first position to the second position. A barrier gate comprising: a generally stationary barrier frame; a pivot member in fixed communication with the barrier frame; a swing arm in rotatable communication with the pivot member, and rotatable with respect to the barrier frame; a barrier arm in fixed communication with the swing arm; a swing arm lock plate, with an opening, the swing arm lock plate in fixed communication with one of the swing arm and the barrier frame; an actuator in fixed communication with the other of the swing arm and the barrier frame, the actuator having a first mode, where an actuating element is extended out from the actuator and into the opening, and having a second mode, where the actuating element is retracted into the actuator, and withdrawn from the opening; at least one force acting on the swing arm such that the force tends to rotate the swing arm from the first position to the second position; where when the actuator is in a first mode, the barrier gate is in a first position, and further when the actuator is in a second mode, the swing arm will generally rotate about 90° from the first position to the second position.

### TECHNICAL FIELD

The present invention relates to a barrier gate, and more particularly to a fail-safe or fail-secure barrier gate.

### BACKGROUND

Manual barrier gates are typically operated by hand and often require a person to move the gate to the up (vertical) or down (horizontal) arm positions. FIG. 1 shows a prior art barrier gate 10 in a horizontal (down) position. In this prior art design the barrier gate 10 comprises a base plate 14, a barrier frame 18, a barrier arm 22; a barrier arm attachment means 26, a pivot attachment means 30; a swing arm 34; a counterweight 38, and a counterweight attachment means 42. FIG. 2 shows the prior art barrier gate 10 in the vertical (up) position. Manual barrier gates are used instead of electrical barrier gates to save on installations costs (power supply to operator, safety devices, control devices) and when there is a requirement that a guard get out of his seat and move to the area near the vehicle and barrier gate arm to check the vehicle before opening the gate. Manual barrier gates have no provision for a semi-automatic remote control movement of the arm to the up or down direction.

There is no known solution to for the semi-automatic control of a manual barrier gate, other than for a fully automatic, electrically operated barrier gate which costs about 65% more than manual barrier gates (this includes installation and requires regular maintenance). Electric barrier gates are not appropriate in explosive or corrosive environments.

Thus there is a need for a barrier gate that overcomes the above listed and other disadvantages.

### SUMMARY OF THE INVENTION

The disclosed invention relates to a barrier gate comprising: a generally stationary barrier frame; a pivot member in communication with the barrier frame; a swing arm in communication with the pivot member, and rotatable with respect to the barrier frame; a barrier arm in fixed communication with the swing arm; an electro-magnet in fixed communication with one of the barrier frame and the swing arm, the electro-magnet is energizable and de-energizable; a strike plate in fixed communication the other of the barrier frame and the swing arm, and magnetically attachable to the electro-magnet when the electro-magnet is energized, and when the strike plate is magnetically attached to the electro-magnet the barrier gate is in a first position, when the swing arm is rotated generally about 90° from the first position the barrier gate is in an second position; at least one force acting on the swing arm such that the force tends to rotate the swing arm from the first position to the second position; where when the electro-magnet is energized and magnetically attached to the strike plate, the barrier gate is in a first position, and further when the electro-magnet is de-energized when in the first position, the swing arm will generally rotate about 90° from the first position to the second position.

The disclosed invention is also related to a barrier gate comprising: a generally stationary barrier frame; a pivot member in communication with the barrier frame; a swing arm in communication with the pivot member, and rotatable with respect to the barrier frame; a barrier arm in fixed communication with the swing arm; a swing arm lock plate, with an opening, the swing arm lock plate in fixed communication with one of the swing arm and the barrier frame; an actuator in fixed communication with the other of the swing arm and the barrier frame, the actuator having a first mode, where an actuating element is extended out from the actuator and into the opening, and having a second mode, where the actuating element is retracted into the actuator, and withdrawn from the opening; at least one force acting on the swing arm such that the force tends to rotate the swing arm from the first position to the second position; where when the actuator is in a first mode, the barrier gate is in a first position, and further when the actuator is in a second mode, the swing arm will generally rotate about 90° from the first position to the second position.

### BRIEF DESCRIPTION OF THE DRAWINGS

The present disclosure will be better understood by those skilled in the pertinent art by referencing the accompanying drawings, where like elements are numbered alike in the figures, in which:

FIG. 1 is a barrier gate in a horizontal position;

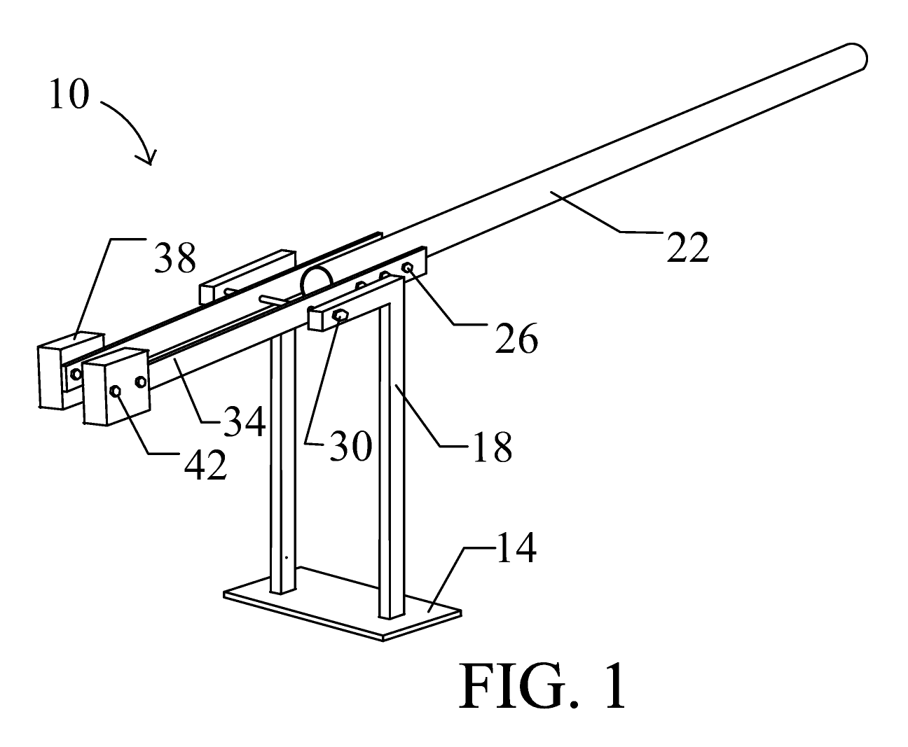

FIG. 2 is a barrier gate in a vertical position;

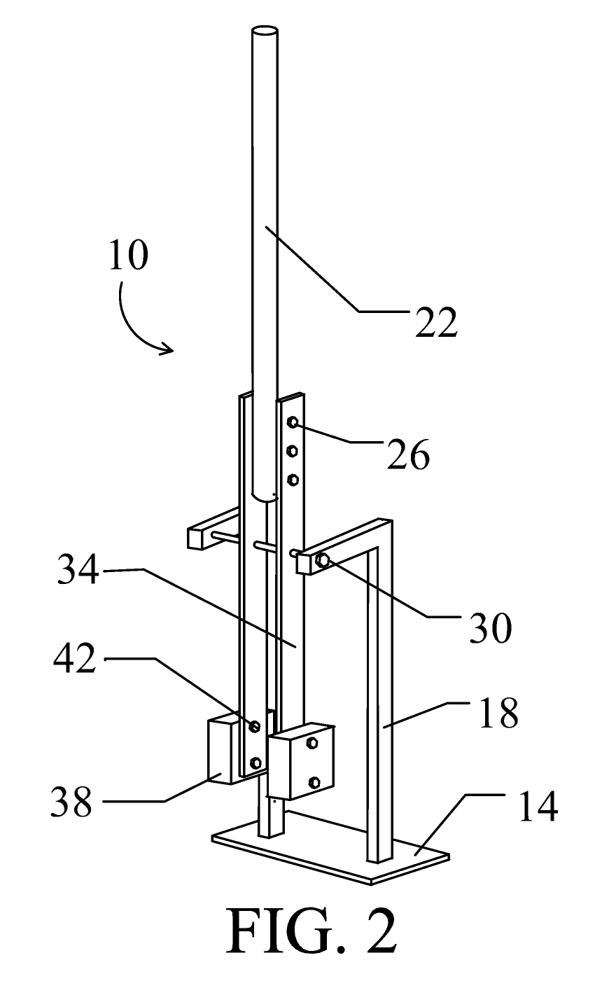

FIG. 3 is a disclosed barrier gate with an electro-magnet in a horizontal position;

FIG. 4 is a disclosed barrier gate with an electro-magnet in a vertical position;

FIG. 5 is a disclosed barrier gate with an actuator in a horizontal position;

FIG. 6 is a disclosed barrier gate with an actuator in a vertical position;

FIG. 7 is a disclosed barrier gate with a rotational spring system; and

FIG. 8 is a disclosed barrier gate with a spring system.

### DETAILED DESCRIPTION

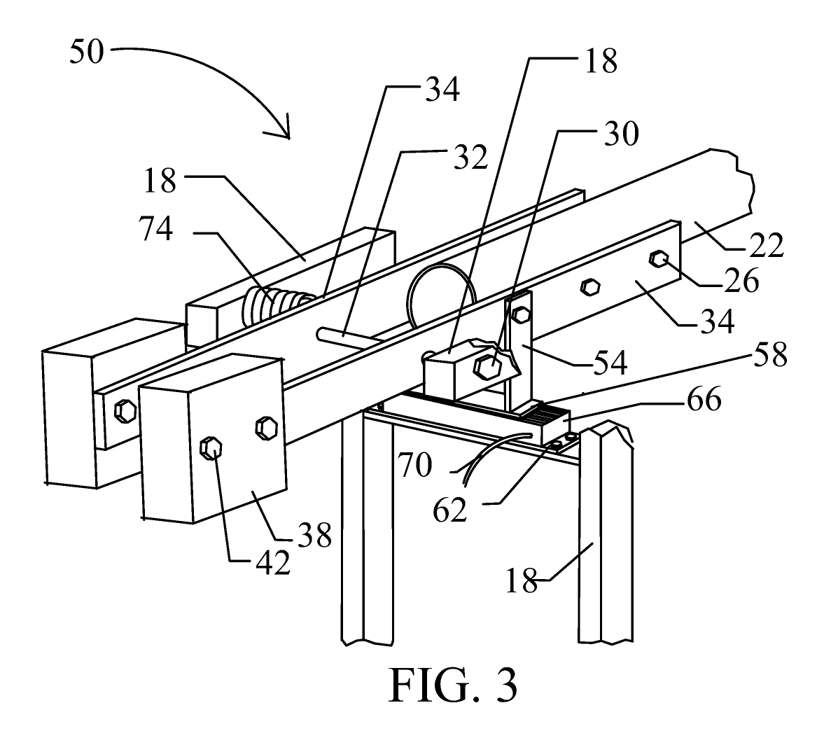

FIG. 3 shows one embodiment of the disclosed barrier gate 50. In this embodiment, a strike plate mount 54 is attached to the swing arm 34. A strike plate 58 is attached to the strike plate mount 54. Attached to the barrier frame 18 is a magnet mount 62. Attached to the magnet mount 62 is an electro-magnet 66. In one embodiment the electro-magnet may be an EMX Corp GLOCK1200 magnetic lock, that features an outdoor housing; a ½ inch Conduit Connection; 12V or 24V DC Operation; about 1200 lb. holding force; a spring loaded strike plate for quick release, and may be about 7″ long, about 2.5″ wide and about 1.5″ high. Of course, a person of ordinary skill in the art will recognize that any suitable electro-magnet will fall within the scope of this application. A power supply cable 70 is shown attached to the electro-magnet 66. The electro-magnet 66 and strike plate 58 are configured to allow the electro-magnet 66 to energize and magnetically attach to the strike plate 58, thus holding the barrier arm 22 in a horizontal position. When the electro-magnet 66 is de-energized, the electro-magnet 66 is not longer magnetically attached to the strike plate 58, and the barrier arm 22 and swing arm 34 are free to rotate about a pivot member 32, which is in communication with the pivot attachment means 30. A spring 74, such as but not limited to a torsion spring, is in communication with the swing arm 34 and the barrier frame 18, and is configured to exert a force on the swing arm 34, such that the swing arm will tend to rotate into a vertical position when the electro-magnet 66 is not energized. In order to move the barrier arm from the vertical position to the horizontal position, a person will be required to manually close the gate. Thus in operation, when the barrier arm 22 is in the horizontal position, the electro-magnet 66 will be energized, thereby holding the barrier arm 22 and swing arm 34 in the horizontal position. When the electro-magnet 66 is de-energized, the torsion spring 74 tends to rotate the swing arm 34 and barrier arm 22 into the vertical position. In order to move the barrier arm 22 from the vertical to horizontal position, a person manually closes it. In another embodiment, the counterweight 38 may be configured to tend to rotate the barrier arm 22 into a vertical orientation, without the need of the torsion spring 74.

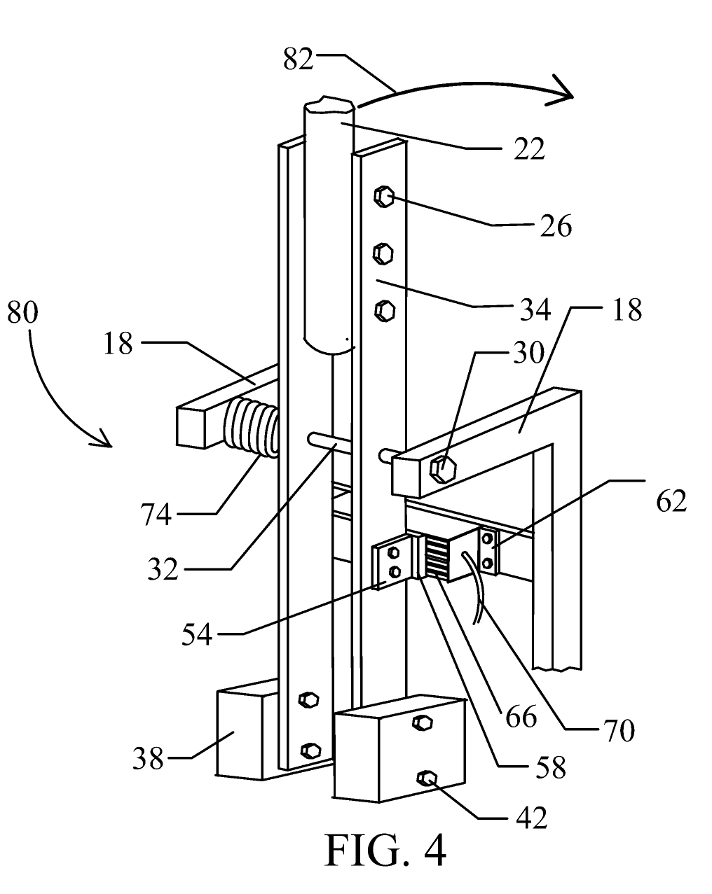

FIG. 4 shows another embodiment of the disclosed barrier gate 80. In this embodiment, when the electro-magnet 66 is energized, and attached to the strike plate 58, the barrier arm 22 is in a vertical orientation. When the electro-magnet 66 is de-energized, the barrier arm 22 will rotate down (in the direction of the arrow 82) to a horizontal position. The barrier arm 22 is urged in its downward rotation by the torsion spring 74, that tends to move the swing arm 34 down. In another embodiment, the counterweight 38 may be configured such that the barrier arm 22 tends to rotate into a horizontal orientation, without the need of the torsion spring 74. In order to move the gate from the horizontal orientation to a vertical orientation, a person is required to manually open the gate.

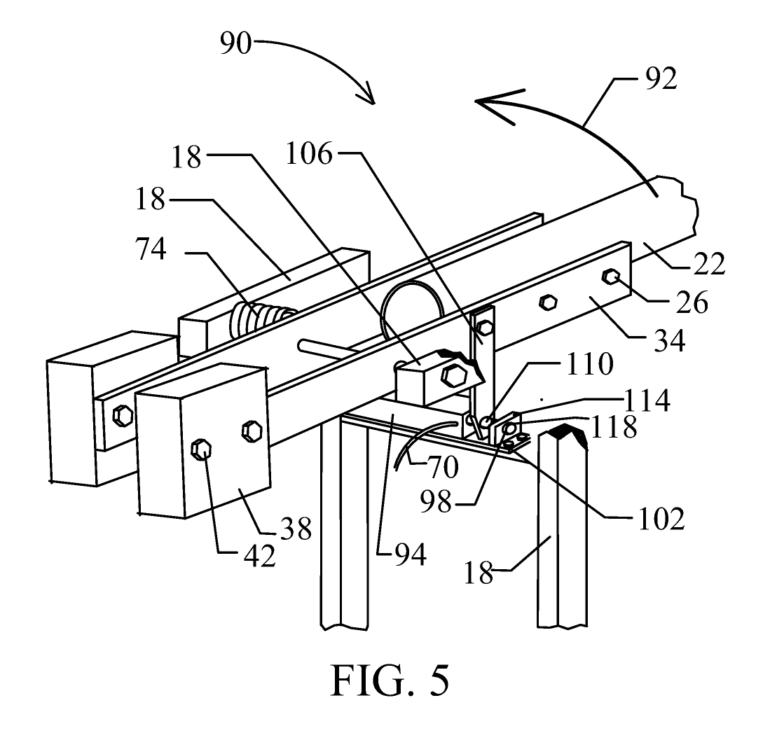

FIG. 5 shows another embodiment of the disclosed barrier gate 90. In this embodiment, rather than an electro-magnet, the device has an actuator 94, with an actuating member 98 that is moved by the actuator 94. The actuator 94 is attached to an actuator mount 102 which is attached to the barrier frame 18. When the actuator 94 actuates in a first mode it can move the actuating member 98 into a swing arm lock plate 106, which is in fixed communication with the swing arm 34. The swing arm lock plate 106 may have an opening or hole 110 to accept the actuating member 98, thus causing the swing arm 34 to be locked with respect to the barrier frame 18, and thus unable to rotate from the horizontal position (shown) to a vertical position. There may also be an optional barrier frame lock plate 114, with an opening or hole 118 to accept the actuating member 98. When the actuator 94 actuates in second mode, the actuating member 98 is moved out of the swing arm lock plate 106 and the swing arm lock plate hole 110, as well as the optional barrier frame lock plate 114 and barrier frame lock plate hole 118, thereby allowing the swing arm 34 and barrier arm 22 to rotate upward, see the arrow 92, from the horizontal position (shown) to a vertical position. The upward rotation may be caused by a torsional spring 74. In another embodiment, the counterweight 38, without the need for a torsional spring 74, may be configured to cause the barrier arm 22 and swing arm 34 to tend to rotate into the vertical position.

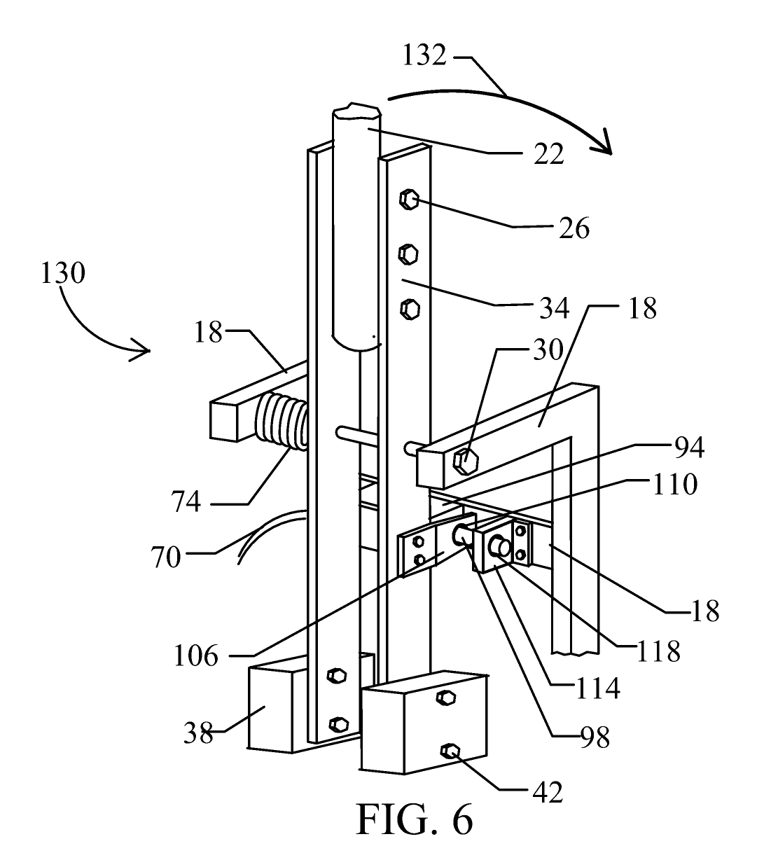

FIG. 6 shows another embodiment of the disclosed barrier gate 130. In this embodiment, when the gate is in locked orientation, the gate arm 22 and swing arm 34 is in a vertical position. When the actuator 94 actuates in one mode, the actuating member 98 withdraws from the swing arm lock plate 106 and the optional barrier frame lock plate 114, thus allowing the swing arm 34 and barrier arm 22 to rotate down (see the arrow 132) into a horizontal position. The torsion spring 74 may tend to rotate the swing arm 34 into the horizontal position. In other embodiments, the counterweight 38 may be configured such that the barrier arm 22 and swing arm 34 tends to rotate to the horizontal position with the need for a torsion spring 74.

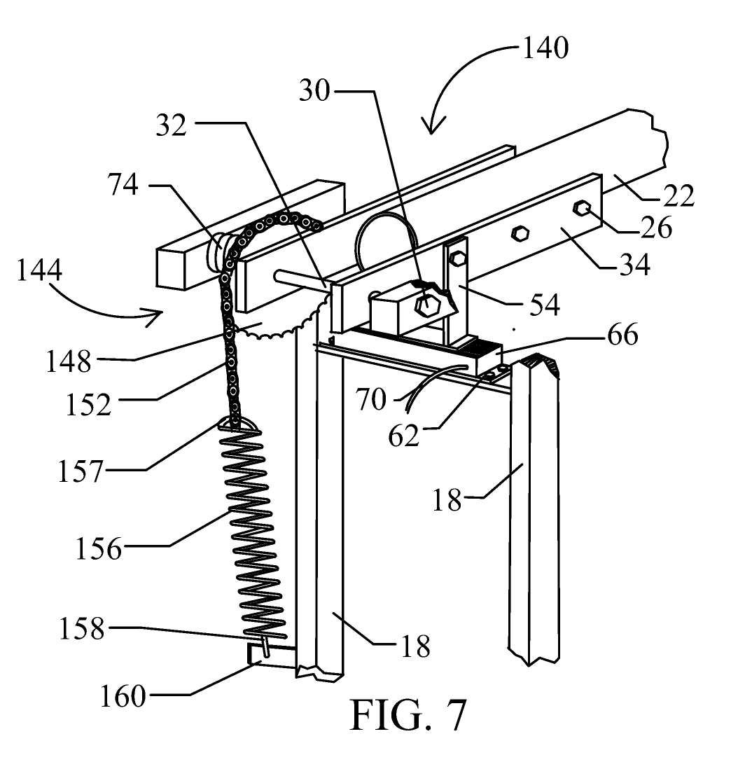

FIG. 7 shows another embodiment of the disclosed barrier gate 140. In this embodiment, rather (or in combination with) than using a counterweight, the barrier gate 140 uses a rotational spring system 144 for a counter balance. The rotational spring system 144 comprises a rotating member 148 that is rotatively attached to the pivot member 32 and fixed to the swing arm 34. The rotating member may be a sprocket, gear, pulley or sheave. In one embodiment, the rotating member may be a standard 6 inch OD/36 tooth sprocket for use with #41 roller chain and with a ¾ inch bore shaft with keyway or clamping bolt as part of the sprocket. In communication with and attached to the rotating member 148 is a flexible member 152. The flexible member may be a chain, wire, strap, cable, or any other suitable device able to transmit force from the spring 156 and communicate translational movement from the rotating member 148 to the spring 156. The flexible member 152 is fixed to a first end 157 of a spring 156. The second end 158 of the spring 156 is fixed to a spring mounting bracket 160. The spring mounting bracket 160 is attached to the barrier frame 18. In another embodiment, the second end 158 of the spring 156, or the spring mounting bracket 160, may be attached to a fixed point, such as to the ground, or a nearby building or other generally fixed structure. In this disclosure, the term “fixed point” shall mean a location that is generally fixed with respect to the barrier gate, and includes the barrier frame, the ground, nearby fixed structures and nearby buildings. In one embodiment the spring may be a garage door style extension spring, which is a single one piece spring, with length over coils of about 10″; and outside diameter of about 1 and 5/16″, with plug ends, max allowable stretch of about 6 inches and a wire diameter and gauge of (0.177) #7. This embodiment of the barrier gate 140 is shown with an electro-magnet 66 used as the mechanism to hold the barrier arm 22 in a horizontal position, however one of ordinary skill will understand that the electro-magnet 66 may be replaced with the actuator embodiment disclosed above. In addition, one of ordinary skill will understand that the above described embodiment may be configured such that the electro-magnet 66 holds the barrier arm 22 in a vertical position, until de-energized.

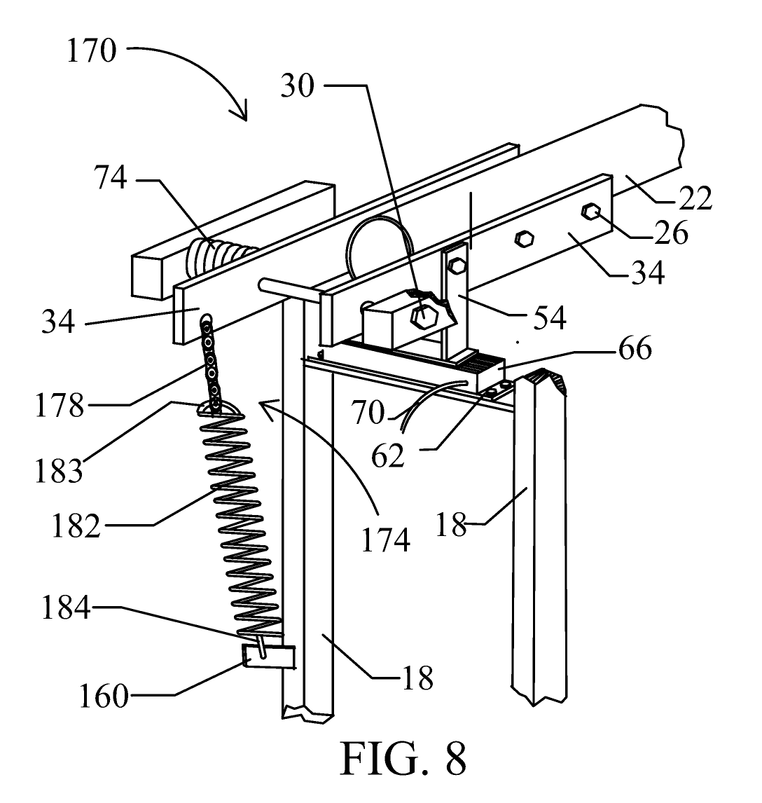

FIG. 8 is another embodiment of the disclosed barrier gate 170. In this embodiment, rather (or in combination with) than using a counterweight, the barrier gate 170 uses a spring system 174 for a counter balance. The spring system 174 comprises a flexible member 178. The flexible 178 member may be a chain, wire, strap, cable, or any other suitable device able to transmit pulling force from the spring 182 and communicate translational movement from the swing arm 34 to the spring 182. The flexible member 178 is fixed to a first end 183 of the spring 182. The second end 184 of the spring 182 is fixed to a spring mounting bracket 160. The spring mounting bracket 160 is attached to the barrier frame 18. In another embodiment, the second end 184 of the spring 182, or the spring mounting bracket 160, may be attached to a fixed point, such as to the ground, or a nearby building or other generally fixed structure. In one embodiment the flexible member may be an ANSI B29-1 #41 Roller Chain, with an about 1500 lb load limit or an about 500 lb load limit. This embodiment of the barrier gate 170 is shown with an electro-magnet 66 used as the mechanism to hold the barrier arm 22 in a horizontal position, however one of ordinary skill will understand that the electro-magnet 66 may be replaced with the actuator embodiment disclosed above. In addition, one of ordinary skill will understand that the above described embodiment may be configured such that the electro-magnet 66 holds the barrier arm 22 in a vertical position, until de-energized.

It should be noted that in the disclosed embodiments, the electro-magnet and actuator are shown in fixed communication with the barrier frame, and the strike plate and swing arm lock plate are in fixed communication with the swing arm. However, one of ordinary skill in the art will recognize that embodiments with the electro-magnet or actuator in fixed communication with the swing arm, and the strike plate or the swing arm lock plate in fixed communication with the barrier frame are also encompassed by this disclosure. Also, the pivot member 32 may be fixed with respect to the barrier frame, or it may be rotatable with respect to the barrier frame.

The disclosed invention has many advantages. The disclosed barrier gates may be used in a new semi-automatic remote control emergency mode. Some of the uses are for emergency closure of a flooding road, refineries that need restricted access to a plant during a fire and any other type of remote closure that can be initiated remotely via radio receiver/transmitter, manual barrier hardwired to a control device or central control station input to manual barrier. The semi-automatic action of the disclosed barrier gate would be a one direction (of the arm) automatic control with manual (by hand) reset of the arm to its original position after the automatic triggering movement of the arm. The disclosed barrier may use either solar power or low voltage 12 VDC power to operate. Other advantages would be that it requires less maintenance and costs about 65% less than known electric barrier gates. The disclosed barrier gate is suitable in explosive or corrosive environments due to the limited electrical components.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A barrier gate comprising:
a generally stationary barrier frame;
a pivot member in communication with the barrier frame;
a swing arm in communication with the pivot member, and rotatable with respect to the barrier frame;
a barrier arm in fixed communication with the swing arm;
an electro-magnet in fixed communication with one of the barrier frame and the swing arm, the electro-magnet is energizable and de-energizable;
a strike plate in fixed communication the other of the barrier frame and the swing arm, and magnetically attachable to the electro-magnet when the electro-magnet is energized, and when the strike plate is magnetically attached to the electro-magnet the barrier gate is in a first position, when the swing arm is rotated generally about 90° from the first position the barrier gate is in a second position;
at least one force acting on the swing arm such that the force tends to rotate the swing arm from the first position to the second position;
wherein when the electro-magnet is energized and magnetically attached to the strike plate, the barrier gate is in a first condition, and further when the electro-magnet is de-energized when in the first condition, the swing arm will generally rotate about 90° from the first position to the second position.

2. The barrier gate of claim 1, further comprising:
a counterweight attached to the swing arm, the counterweight providing a force tending to rotate the swing arm from the first position to the second position.

3. The barrier gate of claim 1, further comprising:
a torsion spring in communication with the barrier frame and the swing arm, the torsion spring providing a force tending to rotate the swing arm from the first position to the second position.

4. The barrier gate of claim 1, wherein when the barrier gate is in a first position, the barrier arm and swing arm are generally in a horizontal orientation, and when the barrier gate is in a second position, the barrier arm and swing arm are generally in a vertical orientation.

5. The barrier gate of claim 1, wherein when the barrier gate is in a first position, the barrier arm and swing arm are generally in a vertical orientation, and when the barrier gate is in a second position, the barrier arm and swing arm are generally in a horizontal orientation.

6. The barrier gate of claim 1, further comprising:
a rotational spring system in communication with the barrier frame and the swing arm, the rotational spring system providing a force tending to rotate the swing arm from the first position to the second position, the rotational spring system comprising:
a rotating member that is in rotatable communication with the pivot member, and in fixed communication with the swing arm;
a flexible member in communication with and attached to the rotating member;
a spring, with a first end and a second end, the first end attached to the flexible member, the second end in fixed communication with a fixed point.

7. The barrier gate of claim 6, wherein the rotating member is selected from the group consisting of a sprocket, gear, pulley and sheave, and wherein the flexible member is selected from the group consisting of a chain, wire, strap, and cable.

8. The barrier gate of claim 1, further comprising:
a spring system in communication with the barrier frame and the swing arm, the spring system providing a force tending to rotate the swing arm from the first position to the second position, the rotational spring system comprising:
a flexible member in communication with and attached to the swing arm;
a spring, with a first end and a second end, the first end attached to the flexible member, the second end in fixed communication with a fixed point.

9. The barrier gate of claim 6, wherein the flexible member is selected from the group consisting of a chain, wire, strap, and cable.

10. The barrier gate of claim 1, further comprising:
a second electro-magnet in fixed communication with one of the barrier frame and the swing arm, the second electro-magnet is energizable and de-energizable; and
wherein the strike plate is configured to magnetically attach to the second electro-magnet when the second electro-magnet is energized and when the barrier gate is in a second position.

11. A barrier gate comprising:
a generally stationary barrier frame;
a pivot member in communication with the barrier frame;
a swing arm in communication with the pivot member, and rotatable with respect to the barrier frame;
a barrier arm in fixed communication with the swing arm;
a swing arm lock plate, with an opening, the swing arm lock plate in fixed communication with one of the swing arm and the barrier frame;
an actuator in fixed communication with the other of the swing arm and the barrier frame, the actuator having a first mode, where an actuating element is extended out from the actuator and into the opening, and having a second mode, where the actuating element is retracted into the actuator, and withdrawn from the opening, and wherein when the actuator is in a first mode, the barrier gate is in a first position, and further when the actuator is in a second mode, the swing arm will generally rotate about 90° from the first position to the second position; and
at least one force acting on the swing arm such that the force tends to rotate the swing arm from the first position to the second position.

12. The barrier gate of claim 11, further comprising:
a counterweight attached to the swing arm, the counterweight providing a force tending to rotate the swing arm from the first position to the second position.

13. The barrier gate of claim 11, further comprising:
a torsion spring in communication with the barrier frame and the swing arm, the torsion spring providing a force tending to rotate the swing arm from the first position to the second position.

14. The barrier gate of claim 11, wherein when the barrier gate is in a first position, the barrier arm and swing arm are generally in a horizontal orientation, and when the barrier gate is in a second position, the barrier arm and swing arm are generally in a vertical orientation.

15. The barrier gate of claim 11, wherein when the barrier gate is in a first position, the barrier arm and swing arm are generally in a vertical orientation, and when the barrier gate is in a second position, the barrier arm and swing arm are generally in a horizontal orientation.

16. The barrier gate of claim 11, further comprising:
a rotational spring system in communication with the barrier frame and the swing arm, the rotational spring system providing a force tending to rotate the swing arm from the first position to the second position, the rotational spring system comprising:
a rotating member that is in rotatable communication with the pivot member, and in fixed communication with the swing arm;
a flexible member in communication with and attached to the rotating member;
a spring, with a first end and a second end, the first end attached to the flexible member, the second end in fixed communication with a fixed point.

17. The barrier gate of claim 16, wherein the rotating member is selected from the group consisting of a sprocket, gear, pulley and sheave, and wherein the flexible member is selected from the group consisting of a chain, wire, strap, and cable.

18. The barrier gate of claim 11, further comprising:
a spring system in communication with the barrier frame and the swing arm, the spring system providing a force tending to rotate the swing arm from the first position to the second position, the rotational spring system comprising:
a flexible member in communication with and attached to the swing arm;
a spring, with a first end and a second end, the first end attached to the flexible member, the second end in fixed communication with a fixed point.

19. The barrier gate of claim 18, wherein the flexible member is selected from the group consisting of a chain, wire, strap, and cable.

20. The barrier gate of claim 11, further comprising:
a second actuator in fixed communication with the other of the swing arm and the barrier frame, the second actuator having a first mode, where a second actuating element is extended out from the second actuator and into the opening, and having a second mode, where the second actuating element is retracted into the second actuator, and withdrawn from the opening, and wherein when the second actuator is in a first mode, the barrier gate is in a second position.
